(19) United States
(12) Patent Application Publication
(10) Pub. No.: US 2005/0097027 A1
(43) Pub. Date: May 5, 2005

(54) Computer-implemented method and electronic system for trading

(76) Inventor: Sylvan Kavanaugh, Chicago, IL (US)

Correspondence Address: Eric L. Amundsen;Wolf, Greenfield & Sacks, P.C., 600 Atlantic Avenue, Boston, MA, 02210, US

(21) Appl. No.: 10/702,125

(22) Filed: Nov. 5, 2003

(51) Int. Cl. G06F 17/60

(52) U.S. Cl. 705/37

(57) ABSTRACT

A computer-implemented method to establish contract specifications using designations and/or standardized specifications. The specifications may be for a contract with a payout that is related to the dispersion of instrument data, such as financial instrument data. In one aspect, the method to establish contract specifications may be useful in hedging against volatility fluctuations and for directly trading dispersion-based products. In another aspect, an electronic system facilitates the trading of standardized dispersion-based contracts.

### FIELD OF THE INVENTION

The present invention relates generally to computer-implemented methods and systems for establishing contracts and trading contracts based on dispersion.

### BACKGROUND

Futures contracts (“futures”), forwards contracts (“forwards”) and options contracts (“options”) are derivative instruments (“derivatives”) whose values depend on the values of more basic, underlying variables. Forwards and futures obligate holders to buy or sell an instrument on a future date for a certain price. An option gives a holder the right, but not the obligation, to buy or sell an underlying instrument (depending on the type of option) at a future date for a certain price.

These can be used for hedging risk, speculating on price movements and estimating prices at a future date. For example, a farmer who plans to have a large amount of corn ready for sale in two months can lock in a price by entering a forward contract for the sale of a certain amount of corn for a certain price on a certain date two months in the future. In this respect the farmer hedges his risk, or exposure, to changes in the market price of corn. A change in the market price of corn between the contracting date and the sale date will not affect the farmer's sale price. As an example of price estimation, a farmer who is evaluating whether to plant corn might wish to estimate what the selling price of corn will be at the time that his harvest is ready for sale. The futures price of corn on a specified delivery date is related to what people believe the price of corn will be on that date, and can be informative to the farmer.

Traders can also use derivatives to speculate on the market. A trader could enter into a forward contract in which he agrees to sell corn at a specific price on a certain future date. If the spot price of corn on that future date turns out to be lower than the price for which he agreed to sell it through the forward contract, the trader can close his position and turn a profit. With options and futures, and sometimes forwards, many of the standardized terms or specifications of the contract are published. For purposes herein, the words “specifications”, “terms”, and “conditions” are interchangeable with respect to contractual agreements.

To simplify the trading of these derivatives, exchanges or other centralized marketplaces standardize contract specifications. Various specifications are published by an exchange, leaving traders to bargain only about prices and quantities. For example, contract specifications for a futures contract on an agricultural commodity may specify a grade of commodity, a date of delivery, a place of delivery and a volume per contract. Two trading entities can then enter a contract by referencing the contract specifications and coming to an agreement on a number of contracts and a price. Further, to lessen concerns about credit-worthiness of trading counterparties, the contracting by the trading entities and the exchanging of payments associated with the contracts are often performed through high-credit intermediaries such as clearinghouses, clearing firms, clearing corporations, banks, or other intermediaries. Centralized markets and standardized contracting provides flexibility to trading entities by allowing them to change or even close their positions by entering another contract that has an opposite position.

Forwards and swaps are often not as interchangeable as other financial instruments such as futures and options as they are typically customized arrangements, often made between two parties that negotiate directly with one another. While the customization of forwards and swaps can add flexibility to the terms of a contract, the ability to close one's position or convert a position to cash can be significantly restricted as compared to other derivatives.

A volatility swap is a type of forward contract in which a payoff is made at maturity based on the difference between the realized historical volatility and a previously specified volatility level. At the time of contract formation, an agreement is made to exchange money at the maturity date. The amount of the payment, and who pays whom, is determined once realized historical volatility can be calculated and compared to the previously specified volatility level.

History shows that there is a constant demand for new types of financial and trading instruments. Options trading evolved as a method for hedging the movements of a stock's value and also became a method for speculation. Volatility swaps came about as a way to hedge volatility risk and to speculate on volatility levels. A method for directly and intuitively trading volatility in a standardized, open and fungible market has yet to be realized. With the advent of electronic trading and computer-based portfolio management, such a method now becomes possible.

### SUMMARY OF INVENTION

According to one illustrative embodiment of the invention, there is provided a computer-implemented method. The method comprises operating a computer to receive from a user indicia of an attribute of an instrument, wherein the instrument attribute may vary over time, and receive from a user indicia defining a time period for use in establishing contract specifications, the time period having an end time. The method further comprises operating a computer to establish contract specifications to periodically measure the instrument attribute during the time period to generate instrument data. The method also comprises operating a computer to establish contract specifications to calculate, after the end time, a contract value as a function of a measure of dispersion of the instrument data, and establish contract specifications to periodically settle gains and losses as a function of market statistics associated with contracts that are based on the instrument attribute and the time period.

In another embodiment of the invention, an electronic system is provided comprising a memory unit, and input interface to receive data from trading entities, and a processor operatively connectable to the memory unit and input interface and provide it with a program which, when executed by the processor, effectuates control of the memory unit, input interface and operations of the electronic system. The program effectuates control of the electronic system to allow a first trading entity to input a first set of order data indicative of an order price, a type of contract, and a position, wherein the indicated type of contract is a contract that specifies an instrument having an instrument attribute that may vary over time, a time period having an end time, a method to periodically measure the instrument attribute to generate instrument data, and a method to calculate, after the end time, a contract value as a function of a measure of dispersion of the instrument data. The program also effectuates control of the electronic system to search the memory for a second set of order data that indicates the same type of contract as the first set of order data, a position opposite to the position of the first set of order data, and an order price that is compatible with forming a contract between the first trading entity and a second trading entity, the second set of order data having been provided by the second trading entity. The program effectuates control of the electronic system to initiate the formation of a contract between the first trading entity and an intermediary, and to initiate the formation of a contract between the second trading entity and the intermediary.

In a further embodiment of the invention, a computer-implemented method comprises the act of operating a computer to form a first electronic order by receiving indicia from a user and processing the indicia into the first electronic order. The indicia may comprise a designation of an instrument having an instrument attribute that may vary over time and can be measured to generate instrument data, a definition of a time period having an end time, an order price, and a contract type, wherein the indicated contract type includes specifications for a trading entity to make or receive a payment after the time period, the payment calculated as a function of a measure of dispersion of the instrument data. The method may further comprise operating the computer to communicate the first electronic order to a computer system programmed to facilitate matching the first electronic order to a second, complementary order, and receive confirmation of the first electronic order having been matched to a second, complementary order.

Other features and aspects of the invention will be apparent from the detailed description, the claims and the drawings, which are to be read together.

### BRIEF DESCRIPTION OF THE DRAWINGS

In the drawings, wherein like designations are to like elements,

FIG. 1 shows an illustrative embodiment of a computer-implemented method to establish contract specifications;

FIG. 2 shows an illustrative embodiment of a method to establish and settle dispersion-based contracts;

FIG. 3 shows an illustrative embodiment of an electronic system for establishing contract specifications; and

FIG. 4 shows an illustrative embodiment of a computer-implemented method to enter into a dispersion-based contract.

### DETAILED DESCRIPTION

This invention is not limited in its application to the details of the embodiments set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, “having”, “containing”, or “involving”, and variations thereof herein, is meant to encompass the items listed thereafter and equivalents thereof as well as additional items.

Options and other derivatives are useful for investors as investment and trading instruments for hedging against price fluctuations in an instrument. However, options can leave traders exposed to changes in volatility.

Volatility is one type of a measure of the dispersion of data over time. For example, the daily price changes of an equity may be summarized by calculating the equity's daily return, that is, the percentage change of the equity price from one day to the following day. A dispersion of measurements of the equity's daily return will exist after a multi-day time period, such as one month. A measure of the dispersion of the equity's daily returns can be provided by various dispersion measurements such as a deviation, a variance, a range, a trimmed range, or a full-width at half maximum. Volatility is typically defined as being related to standard deviation, often an annualized standard deviation. Often, volatility is calculated by using the daily close-to-close lognormal percentage price changes as inputs for various mathematical approaches which are described below. It is important to note that in addition to assets such as equities, bonds, currencies, etc., dispersion calculations may be used to summarize the spread of return data for other instruments. Dispersion calculations may also be used to summarize the spread of data other than return data. In some cases, rather than summarizing the spread of return data for a tradeable instrument, the spread of data for measurements of a non-tradeable variable such as weather data may be summarized or evaluated.

An option price is generally a function of several variables including: underlying instrument price; strike price; time to expiration; interest rates; dividends (where applicable); and expected volatility. With the exception of volatility and to some extent dividends, it is possible to hedge the above-listed variables in a relatively straightforward manner. For example, exposure to interest rates can be hedged with treasury bills, notes, bonds, or other positions, and exposure to an underlying instrument price can be hedged with the purchase or sale of the underlying instrument.

Because many of the variables other than volatility are known or can be hedged, the price of an option is often related to the market consensus for what the volatility of the underlying instrument will be during the life of the option. This market consensus is referred to as an implied volatility, and based on the trading prices of an option, one can calculate the implied volatility of the underlying instrument. It is important to note that implied volatility represents the market-based expectation of future volatility, and does not represent an actual calculation of the past or present volatility of the underlying instrument. Additionally, prices of different options (e.g., different strike prices or different time periods) based on the same underlying instrument can provide different implied volatilities.

A calculation of implied volatility from an option price includes many assumptions. The various inputs which go into a pricing model, including interest rates, dividends and time to expiration, are typically specified. Conventions are set regarding time, such as trading days versus business days, partial days, and which types of options pricing model to use. Two different systems of calculating implied volatility may provide different results because of differences in the above assumptions.

One example of an existing volatility benchmark or index that quantifies the expected future volatility of an underlying instrument is the VIX (Chicago Board Options Exchange Volatility Index). The VIX is a summary of the thirty-day implied volatility of the S&P 500 Index (SPX). The rules for calculating the VIX are explicitly defined by the Chicago Board Options Exchange so that investors and traders can educate themselves to fully understand what the VIX represents. The VIX calculation uses no data on historical volatility or previous prices of puts and calls. In this respect, the VIX covers a future time period of thirty days, but the thirty-day time period advances with each passing day. The VIX does not allow a trader to take a direct position on what the realized volatility of the S&P 500 Index will be on a future date.

By hedging the other variables that factor into an option price, options can be used as an indirect method for trading volatility. However, this method of trading can require substantial time and effort, multi-step management, constant attention and strict discipline. These characteristics are not desirable to traders, investors, brokers, or other trading entities for whom simplicity and time management are significant factors. If one were able to directly take a position on volatility and also have the ability to quickly change that position, it could help alleviate many of the difficulties associated with current methods of indirectly trading volatility. A direct trade of volatility would allow for greater transparency of a significant risk factor and the trading of standardized agreements or contracts would allow for efficient modification of volatility positions.

Existing volatility and variance swaps can be used to hedge volatility risk or to assert a position on volatility without the need to trade options. Volatility swaps are forward contracts and are often negotiated on a non-standardized, case-by-case basis directly between a buyer and a seller. Non-standardized forward contracts are not fungible and therefore it can be difficult to close one's position by contracting with a third party. With varying types of volatility swap contracts being traded among different parties, matching contracts to close one's position can be inefficient and time-consuming. In fact, if a first trading entity has formed a contract with a second entity, and no third, financially-independent entity enters into identical types of contracts, the first and second trading entities can find it difficult to close their positions. For purposes herein, two orders are considered financially-independent orders when the two entities with a financial stake in the orders do not have a financial stake in one another.

Embodiments of the invention disclosed herein are directed to methods and systems to form contracts that are based on the dispersion of measurements of an instrument attribute, the measurements of the instrument attribute having been collected during a defined period of time. For ease of understanding, and without limiting the scope of the invention, the inventive method and system to which this patent is addressed are disclosed particularly in connection with a computer-implemented method and an electronic system. It should be appreciated, however, that the inventive method and system may be embodied in systems and methods that do not use or require computers or electronic systems. In other embodiments, portions of the method or system are computer-implemented, and other portions are not computer-implemented.

One of the embodiments of the inventive method provides a way for a trading entity, such as an investor or a trader, to take a position on what the dispersion of the attribute data of an underlying instrument will be during a defined time period. By establishing certain contract specifications, the trading entity can commit to future payoffs (or payouts) which are based on the dispersion that actually occurs during the time period. Usually, because at least part of the time period, or the entire time period, is in the future when the trading entity commits to the position, the final contract payoff is not determined until the time period expires. The trading entity may decide, however, to close the position before the time period expiration, even though the final contract payoff is not yet determinable.

A financial instrument that allows for direct, fungible, liquid trading based on realized dispersion and a computer-based method for trading such an instrument would be desirable for several reasons. Such an instrument would provide traders with an efficient method for hedging their volatility exposure in a straightforward manner. For example, exposure to changes in future implied volatility and future realized volatility makes the future value of an option unpredictable. A financial instrument having a settlement value based on the volatility that has occurred during the financial instrument's lifetime could be useful for hedging this exposure. With options trading, volatility can be traded indirectly, but as mentioned above, indirect trading usually requires multi-step position management, constant attention and strict discipline. Embodiments of the inventive method allow for direct, fungible, liquid trading of volatility with a low concern for credit-worthiness of trading entities. Direct, liquid trading of interchangeable volatility contracts allows an electronic platform to be created for efficient, fungible, and transparent trading of dispersion. The various advantages and attributes of the inventive method and system described herein are not intended to be limiting, are not intended to define the scope of the invention, and are not necessarily required to be present.

Exchanges and financial marketplaces use electronic transactions for speed and ease of trading and settlement. The tracking of performance and other associated activities also rely on computer networks and electronic communication. It would be desirable to have a computer-implemented method, process and system for facilitating or managing a marketplace that provides a liquid and/or fungible market for dispersion-based financial instruments.

Embodiments of the present invention provide for contract specifications of futures contracts to be established such that contracts based on realized dispersion measurements are marked-to-market. Mark-to-market contracts provide for realizing gains and losses on a periodic basis, often daily. Such contracts provide a financial safeguard by decreasing the risk of not receiving payment due to default or bankruptcy. By contracting for daily (or other periodic) settlement, the entire payoff or payout is not deferred until contract maturity. Instead, payments and payouts based on the measurements of realized volatility are made on a periodic basis, such as at the end of each trading day.

Embodiments of the present invention provide a liability distribution which differs from volatility and variance swaps. Some of the embodiments disclosed herein provide contract specifications which require a second trading entity to make a payment to a first trading entity based on the realized volatility. The payment is not calculated as a difference between a realized volatility and a previously specified reference volatility. Instead, the payment by the second trading entity to the first trading entity is directly related to the realized volatility. In such an embodiment, the first trading entity makes a front-end payment to enter into the contract, and can easily and transparently sell his right to receive the end-of-contract payment. Because the second trading entity receives a front-end payment, the second trading entity is not put at a credit risk. If the first trading entity sells his interest in the contract to a third entity, the second trading entity is still not put at a credit risk, because payment has already been made.

Embodiments of the inventive method also allow for volatility estimation. With numerous entities trading standardized futures on realized volatility, a straightforward analysis may lead to the market consensus for future realized volatility.

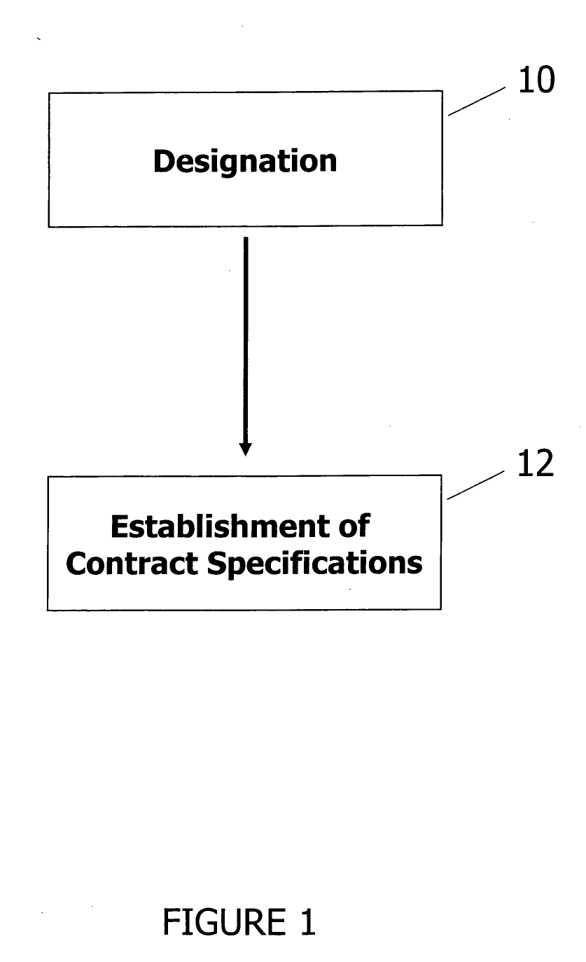

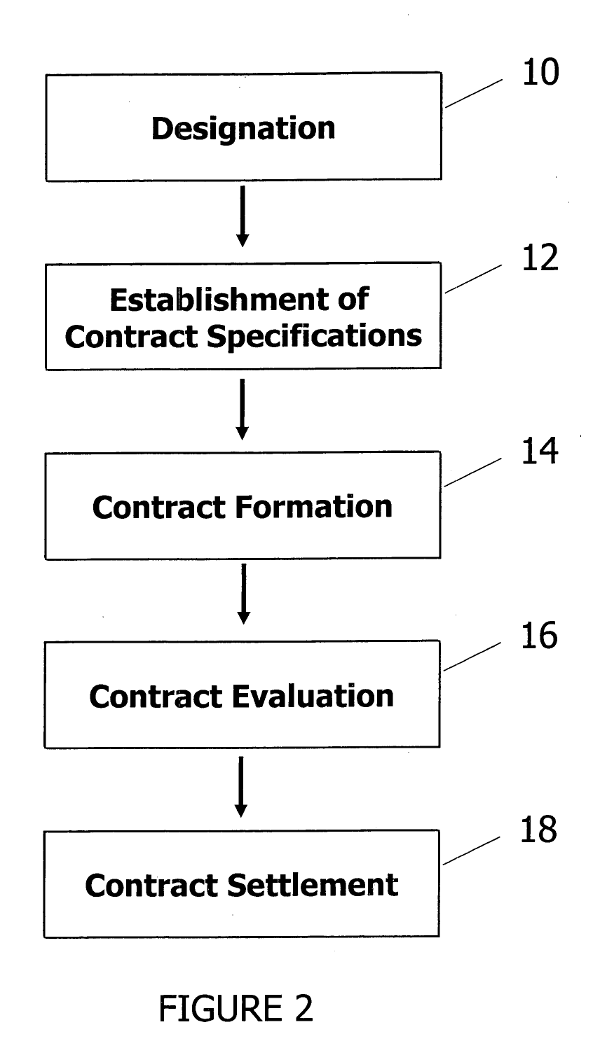

A general outline of acts corresponding to one embodiment of the inventive method is shown in FIG. 1. In the illustrated embodiment, a computer-implemented method is presented for establishing contract specifications. FIG. 2 illustrates another embodiment, comprising a method to establish contract specifications, form a contract, evaluate the contract, and settle the contract. The acts illustrated in FIGS. 1 and 2 do not necessarily need to be performed in the order shown, nor are the acts required to be distinctly separate acts. Not all of the acts shown in FIGS. 1 and 2 are necessarily required to achieve the advantages discussed above in relation to embodiments of the inventive method and system. Contracts and proposed contracts, as defined herein, may refer to formal contracts, informal contracts, written or oral agreements, or other instruments in which a trading entity commits or proposes to commit to a purchase, sale, trade, or other transfer of consideration. A trading entity may be any entity that can make the trading designations. For example, the trading entity may be a human trader, broker, or investor who decides to take a position on the dispersion of an underlying instrument. A financial institution, credit-worthy intermediary, or an automated trader such as a trading algorithm or a computer may also be considered a trading entity.

Designation

An instrument attribute and a time period are designated in an act 10. In some embodiments, the instrument is an asset such as an equity, an index, a future or other security. As discussed above, other types of assets, securities or instruments may be designated, such as bonds, currencies, notes, bills and instruments that are not traded but have at least one attribute that varies over time and can be measured. For example, the daily closing price of a selected equity may be designated as an instrument attribute. In another example, the weekly return of a selected equity may be designated as an instrument attribute. In further examples, the intra-period equity price high and low may be designated as an instrument attribute. The designated time period may be a multiple-day period, such as a twenty-eight-day time period, a thirty-five-day time period, or an intra-day time period. The time period may be designated in absolute terms, or in relation to certain events, such as trading days. In some cases, the designation may refer to the close time of a market on a given day as an end time or start time for the time period. The designation of the time period may be of any form that defines a time period. For example, the designation of a start time and an end time may be used to designate the time period, or certain events may trigger a start time or an end time. In other examples, a start time and a time period length may be designated. In still further examples, a start time may be designated along with a certain number of events, such as a number of trading days. In some embodiments, the designated time period may include more than one continuous time period. For example, a time period may include both September 1^{th} to September 30^{th} and November 1^{st} to November 30^{th}. Portions of the designated time period may be in the past, present or future. For example, in one illustrative embodiment, a start time and a time period length are designated and the start time has already occurred.

In some embodiments, the designations may be in the form of references, symbols, or codes which refer to external definitions or designations. In other embodiments, the various designations of act 10 may be in the form of explicit descriptions. In some cases, depending on in-place agreements, industry practice, or past practice, the lack of a certain designation may trigger a default designation or a previously agreed-upon designation. For example, the designation of a certain equity without a designation of a certain attribute may by default designate the daily equity return at market close as the instrument attribute.

Other aspects of a proposed contract may also be designated in act 10, such as whether the proposed contract is based on a historical volatility calculation or other measure of the dispersion of the data. The type of contract being proposed may also be designated in act 10. For example, a volatility futures contract or an option on a volatility futures contract could be designated in act 10. In other examples, an option on a variance futures contract may be designated in act 10. A mark-to-market procedure also may be designated in act 10, or, in many cases, a default or standardized mark-to-market procedure may take effect without any designation. The number of units or number of contracts being proposed also may be designated. In some trades, a certain quantity of units may be assumed based on the type of contract or the identity of the contracting entities.

Establishment of Contract Specifications

Contract specifications are established in an act 12 with reference to the designations of act 10 and other potential inputs. According to one illustrative embodiment, some of the contract specifications are established by referencing various standard specifications which have been previously published or defined. For example, one of the designations from act 10 may trigger the establishment of “Settlement Procedure B” as the settlement procedure for the proposed contract, where “Settlement Procedure B” is a standard settlement procedure described in specifications published by an exchange or other centralized marketplace. The contract specifications may be incorporated exclusively from an exchange through which the contract is being formed, or, in some embodiments, contract specifications external to the exchange may be used or referenced. In some cases, reference may be made to a credit-worthy intermediary or other third party for certain specifications or for dispute settlement specifications or procedures. While act 12 may reference specifications, some or all of the contract specifications may be established without reference to specifications outside of the contract. In other words, some or all of the contract specifications may be fully defined in the proposed contract without the need for referencing specifications defined by an exchange or other financial institutions. For purposes herein, the terms “specify” and “specifications” are intended to include both specifications that are expressly specified and specifications that are implicitly specified as a result of, for example, the adoption of standard specifications or regulations, the incorporation of specifications from other sources, or by making reference to specifications.

Examples of various specifications that may be established in act 12 include, but are not limited to: the underlying variable(s) or instrument(s) used as a basis for the contract; the number of units or dollars involved in the proposed contract; the frequency of marking-to-market; and the time period that is to be evaluated. Establishment of the attribute to be measured and the type of dispersion measurement to be used also may occur in act 12. Some of the contract specifications may not be explicitly established during act 12. In some embodiments, various contract specifications may be implied or known as a matter of convention. In other embodiments, certain contract specifications may be established as part of other acts such as contract proposal, formation or execution.

Other specifications may be established based on designations, and default contract specifications may be established if certain designations are not provided. In some embodiments, there is no allowance for designation beyond a defined set of designations, and the establishment of many of the contract specifications is automatic with reference to already published or defined specifications. Further examples of the types of contract specifications that may be established include: settlement procedures; handling of trading suspensions, market closures, bankruptcies, dividends, or coupons; procedures for handling contingencies; and identification of pricing models, simulation algorithms, and evaluation procedures, among others.

If the contracts are traded on an exchange or in another centralized marketplace, the exchange may have rules and regulations that affect or constitute contract specifications. For example, the exchange or a regulating entity may regulate maximum price fluctuation limits, minimum price fluctuation, and various other parameters to provide uniformity to the contracts being traded.

Formation of Contract

A proposed contract is accepted and a contract is formed in an act 14. A contract may be formed directly between two trading entities, or a contract may be formed through or with one or more intermediaries. For example, futures contracts are often formed in conjunction with a clearinghouse. Further, the buying and selling of contracts may occur with the aid of other entities, such as, for example, exchanges, brokers, brokerage firms, floor traders, trading specialists, clearing firms or clearinghouses.

Contract Evaluation

As part of act 16, a calculation is performed to determine the payment that should occur as a result of the contract. Act 16 may take place at or after the end of the contract. Part of the contract evaluation is a calculation of a measure of dispersion that occurred during the designated time period. The type of dispersion measure and the method of calculating the dispersion measure for a contract is established in the contract specifications, as discussed above in the description of act 12. There are many measures of dispersion, including but not limited to: standard deviation; average deviation; Parkinson volatility; variance; range; trimmed range; full-width half maximum; realized volatility; and historical volatility. Dispersion may also be measured by performing computational simulations. Example methods of these approaches are described below. It is important to note that the described methods of dispersion measurement may be varied and modified and still be within the scope of the invention.

In one illustrative embodiment, the dispersion measurement is accomplished with the calculation of the historical volatility of the instrument returns. For example, if the instrument is an equity, the dispersion measurement may be defined as calculating historical volatility by determining the annualized standard deviation of returns during the time period. The non-annualized historical volatility of an equity may be calculated as follows:

The equity price is tracked once per day over a time period. The price could be measured at market close each day, or market open, or some other defined event or time each day. The natural log of the ratio (Rₜ) of an equity's price on day t to the equity's price on the previous day (t−1) is calculated:

$${R}_{t} = ln \frac{{S}_{t}}{{S}_{t} - 1} . \qquad ( 1 )$$

The average (Rₐᵥₑ) of these day-to-day ratios for a certain number of days (n) is then calculated:

$${R}_{ave} = {\sum }_{n} \frac{{R}_{t}}{n} . \qquad ( 2 )$$

The historical volatility is determined with an equation that calculates the standard deviation of the daily lognormal returns:

$$HistoricalVolatility = \sqrt{\frac{{\sum }_{n} {( {R}_{t} - {R}_{ave} )}^{2}}{n - 1}} . \qquad ( 3 )$$

In many instances, the historical volatility is expressed as an annual percentage, and the result for historical volatility from Equation 3 is multiplied by an annualization factor. In many cases the annualization factor is the square root of the number of trading days in a year, although other figures or formulas can be used.

There are many methods of calculating historical volatility, and alternative formulas for historical volatility may be employed. For example, historical volatility may be calculated without first determining Rₐᵥₑ:

$$HistoricalVolatility = \sqrt{\frac{\sum {R}_{t}^{2}}{n}} . \qquad ( 4 )$$

This approach is often referred to as a non-centered approach. Each type of historical volatility measurement is useful for different situations, and the specific type of measurement calculated is not critical to the invention.

Other approaches and formulas for calculating historical volatility include calculating a standard deviation from the mean of the instrument value (such as equity price), calculating a standard deviation from zero, and calculating a standard deviation from an interest rate, for example a risk-free interest rate. In addition to using a standard deviation to measure dispersion, other statistics such as variance, average deviation, or a hybrid of these statistics may be used. In some embodiments, a weighting scheme may be used to weight certain days, time periods or measurements differently from others.

In other embodiments, a computational simulation is used for measuring dispersion. In one illustrative embodiment, equity prices measured over time are used with a computational simulation to compute a volatility for use in act 16. Using the known measurements of the day-to-day equity price over a time period, a computer-executed simulation can be used to determine whether a hypothetical price of an option that covered the same time period would have resulted in a profit or a loss. The simulation is performed iteratively to determine what hypothetical price would have resulted in a breakeven price (or other target price). As discussed above, a pricing model can be used to calculate an implied volatility based on an option price because the price of an option depends in large part on how volatile traders believe the equity will be. Using the pricing model and the approximately breakeven price from the simulation, a volatility or other measure of dispersion can be calculated.

To estimate whether a hypothetical price of an option would have been profitable or unprofitable over a time period, the simulation uses data from the measurements and a pricing model to step through the progression of the time period. At certain time intervals, the simulation neutralizes the hypothetical option owner's position relative to the changes in the instrument price. After stepping through the time period, a profit or loss can be estimated. If the estimate falls outside a defined distance from a breakeven point, the hypothetical option price can be adjusted accordingly and the simulation can be run again. Alternative hedging approaches may be used and a similar simulation run accordingly.

Of course there are many parameters and assumptions that are decided before the implementation of the computational simulation. For example, a portfolio of option products may be used instead of one option. Options with different strike prices may bring about different results, so choices as to option products may be defined before entering into a contract. Another convention that may be defined before entering into a contract is the method of hedging the position relative to the equity price. Additionally, different pricing models will give different estimates of implied volatility because there are many assumptions and parameters that can vary from model to model. Many different parameters and assumptions are defined so that trading entities can understand how the simulation works before committing to a contract. In some embodiments, instead of defining certain parameters, rules for deciding parameters are defined. While this embodiment is discussed in conjunction with equity prices and equity options, computational simulations may be used to evaluate the dispersion of other instruments such as indexes, futures, currencies, bonds, and so on.

As part of act 16, the amount of payment or other consideration is determined. In one embodiment, the difference between the calculated dispersion and a previously specified futures price (agreed to at contract formation) represents the amount to be settled between trading entities. In other embodiments, a function of this difference increases or decreases the value of the contract. In further embodiments, an initial payment is made to enter the contract and the payoff at contract maturity is equal to the measured dispersion, or a function or multiple thereof. In this embodiment, the buyer may make payment to enter the contract, and the seller may be obligated to make payment at contract maturity. In still other embodiments, a more complex formula may be used to determine the payment on the basis of the calculated historical volatility. For example, a step-wise function or other discontinuous function maybe used to determine the payment. In alternative embodiments the seller may also make payments at certain intervals based on periodic evaluations of dispersion. As should be evident to one of skill in the art, the payment amount may be in terms of money, financial instruments, credit, debt, promissory notes, swaps, or another type of suitable consideration.

In a futures contract, gains and losses may be settled periodically instead of at or after the end of the time period. This procedure is referred to as a mark-to-market procedure. Of course, settlement may occur on an interval schedule other than daily. For purposes herein, the term “after the end of” in conjunction with a contract period or a time period is intended to mean at or after the end of the period.

In some cases, the contract specifications may delineate thresholds wherein crossing the threshold results in an alternative settlement, or a premature end to the contract with rules for the payment amount and settlement method. In these cases, and in others, dispersion measurement, such as the calculation of volatility and/or the performance of computational simulations, may occur before the end of the designated time period.

Contract Settlement

In act 18, a payment, trade, or other transfer of consideration occurs. Settlement of the payment may occur electronically and need not necessarily occur immediately after contract evaluation. In one illustrative embodiment, settlement of the contract occurs three days after the contract is evaluated. Settlement specifications may be established in act 12 and may include any suitable settlement arrangements, agreements or methods.

In some embodiments, credit-worthy intermediaries adopt the position of buyer to each seller, and seller to each buyer. In these cases, settlement is conducted between the trading entities and the intermediary, rather than directly between trading entities. In this manner, the credit-worthy intermediary provides its credit-worthiness to the buyer and the seller, which significantly increases the confidence of trading entities. In some embodiments, the credit-worthy intermediary may be a clearinghouse or a clearing firm.

At any point during the contract, either trading entity may close their position by making a reverse trade. This is possible in a fungible, centralized market because there are multiple market participants, both buyers and sellers, trading standardized contracts. The uniformity of contracts allows buyers and sellers to efficiently closeout or change positions without having to negotiate and analyze numerous contract specifications.

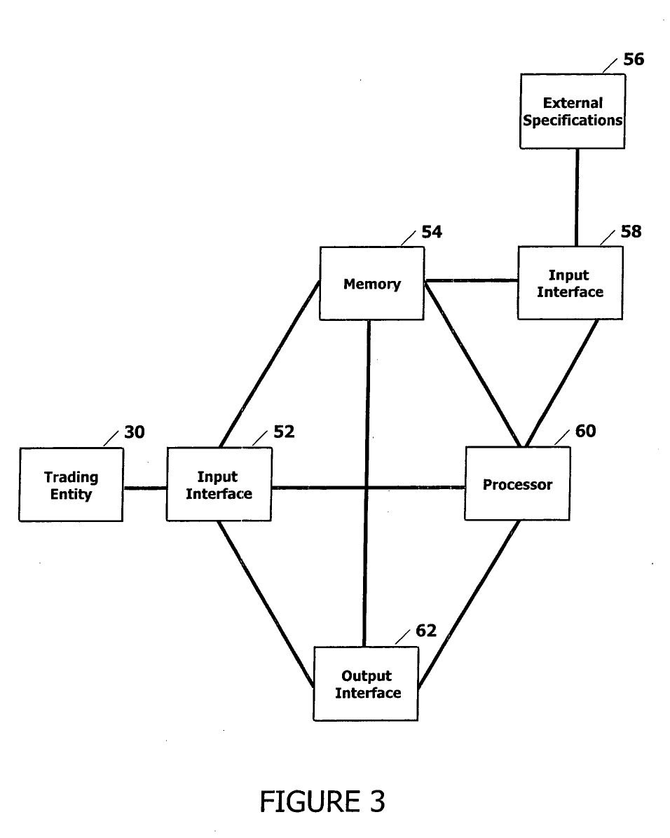

FIG. 3 shows one embodiment of an electronic system for implementing a method for establishing contract specifications as taught herein. In one embodiment, a first trading entity 30 enters designations to a first input interface 52. These designations are stored in memory unit 54. Some the designations may reference external contract specifications 56 which can be retrieved and input via first input interface 52 or a second input interface 58. Default or standard contract specifications may already be stored in memory unit 54. A processor 60 processes the various designations and specifications and forms a proposed contract. The proposed contract may be communicated via an output interface 62, or it is made available on output interface 62 for retrieval by another entity. In some embodiments, further acts such as matching the proposed contract to other proposed contracts may occur within processor 60.

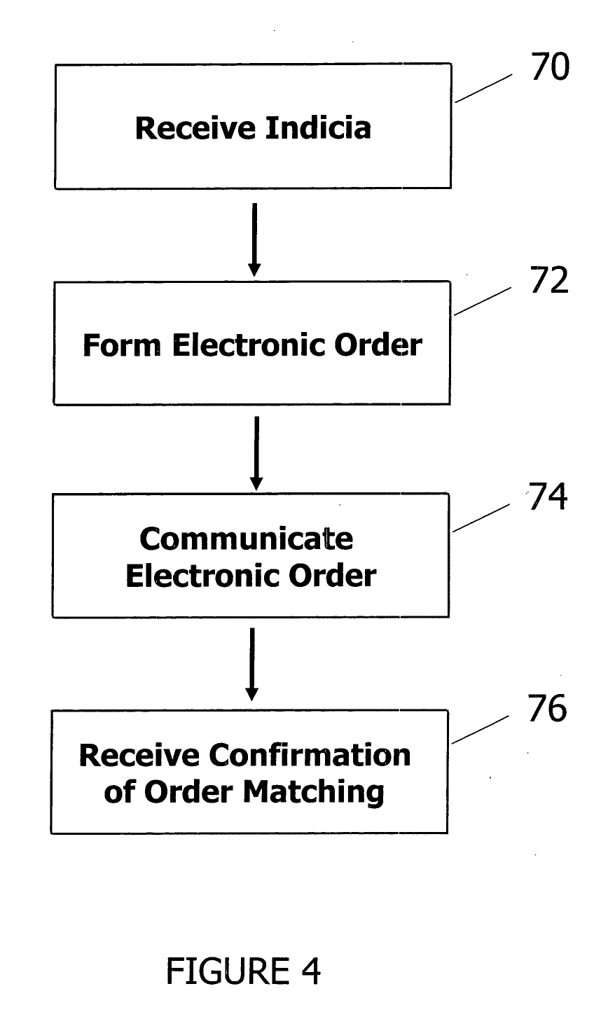

FIG. 4 shows one embodiment of a computer-implemented method to enter into a dispersion-based contract. In act 70, a computer receives various indicia that are relevant to forming a dispersion-based contract. In one example, an indicator of an instrument may be received by the computer. For instance, a user may input an equity ticker symbol to designate a specific equity. The indication of an instrument may inherently indicate an instrument attribute, for example, the daily closing price of an equity. In other embodiments, the indication of an attribute may inherently indicate a certain instrument. For instance, a user may input indicia of “daily index closing price”, and because of a pre-existing agreement, such an input is indicative of a certain index.

Other user inputs may indicate a time period, an order price, or a contract type. In one embodiment, the indicated contract type includes specifications that a trading entity will make or receive a payment based on a function of a measure of dispersion of instrument data. The various indicia need not be input to or received by the computer simultaneously. In some embodiments, the indicia may be an explicit input. For example, the indicia of an order price may be the actual order price. In some cases, however, various codes or symbols may be used to indicate an order price or other values or selections. The user is not required to be a person as automated electronic systems may be programmed to input certain orders. In some situations, a person may provide inputs that are communicated via numerous computer systems, or held for some time, before being received the computer performing the method illustrated in FIG. 4.

In act 72, the computer forms an electronic order by processing the inputted indicia. The formation of the electronic order may be as straightforward as maintaining the various indicia as a set of data, or may comprise gathering data and/or indicia from diverse locations and assembling them into a set of order data. For example, a user may indicate a mid-July to mid-August time period, the daily lognormal return of equity XYZ as an instrument attribute, and a contract type, and indicate that the order price for the contract is to be the current market price of such a contract. The computer may then access the market price from a separate location and assemble the data into an electronic order.

In act 74, the electronic order is communicated to a computer system that is programmed to match the electronic order to a complementary order. The electronic order does not necessarily have to be communicated to a computer system that is separate from the computer that received inputs as the computer that receives the indicia may include the computer system that is programmed to match the electronic order to a complementary order. In some embodiments, the electronic order is communicated to the computer system of an exchange. The exchange's computer system may be programmed to facilitate matching the electronic order to a complementary order, that is, an order which takes the opposite position of the electronic order. For example, the electronic order may include a bid to purchase one contract comprising one-thousand dollars per annualized percentage point of realized volatility of equity price XYZ in July-August. A complementary order may offer to sell one-thousand units of the dispersion of stock XYZ in July-August. The computer system may facilitate matching of the electronic order to a complementary order by directing the electronic order to an appropriate entity such as a broker, a market maker or a floor trader. In act 76, the exchange's computer system, after matching these two orders, may communicate confirmation of the match to the computer on which the various indicia were received, or to another computer, output device or selected recipient.

The methods, acts, steps, systems, and system elements described above may be implemented using a computer and/or a computer system, such as the various embodiments of computers and computer systems described below, including stand-alone and networked computer or computer systems. The methods, acts, steps, systems, and system elements described above are not limited in their implementation to any specific computer or computer system described herein, as many other different machines and operating systems may be used.

Such a computer system may include several known components and circuitry, including a processing unit (i.e., processor), a memory system, input and output devices and interfaces, transport circuitry (e.g., one or more busses), a video and audio data input/output (I/O) subsystem, special-purpose hardware, as well as other components and circuitry, as described below in more detail. Further, the computer system may be a multi-processor computer system or may include multiple computers connected over a computer network or networks, including wireless networks (telephone, WAN or LAN), the computers of which may be located or sited at diverse locations.

The computer system may include a processor, for example, a commercially available processor such as one of the series x86, Celeron and Pentium processors, available from Intel, similar devices from AMD and Cyrix, the 680×0 series microprocessors available from Motorola, the PowerPC microprocessors from IBM and the processors in handheld devices such as personal digital assistants (PDAs) and digital phones (including wireless phones). Many other processors are available, and the computer system is not limited to a particular processor.

A processor typically executes a program called an operating system, of which WindowsNT, Windows95 or 98, WindowsXP, UNIX, Linux, DOS, VMS, MacOS and OS 10 are a few examples, which controls the execution of other computer programs and provides scheduling, debugging, input/output control, accounting, compilation, storage assignment, data management and memory management, communication control and related services. The processor and operating system together define a computer platform for which application programs in high-level programming languages are written. The computer and computer systems employed herein are not limited to a particular computer platform and may include a mix of platforms. The computer system may include a memory system, which typically includes a computer readable and writeable non-volatile recording medium, of which a magnetic disk, optical disk, a flash memory and tape are examples. Such a recording medium may be removable, for example, a floppy disk, read/write CD, DVD or memory stick, or may be permanent, for example, a hard drive.

Such a recording medium stores signals, typically in binary form (i.e., a form interpreted as a sequence of one and zeros). A disk (e.g., magnetic or optical) has a number of tracks on which such signals may be stored. Such signals may define a program, e.g., an application program, to be executed by the microprocessor, or information to be processed by the application program.

The memory system of the computer system also may include an integrated circuit memory element, which typically is a volatile, random access memory such as a dynamic random access memory (DRAM) or static memory (SRAM). Typically, in operation, the processor causes programs and data to be read from the non-volatile recording medium into the integrated circuit memory element, which typically allows for faster access to the program instructions and data by the processor than does the non-volatile recording medium.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer system that implements the methods, acts, steps, systems and system elements described above is not limited thereto. The computer system is not limited to a particular memory system.

At least part of such a memory system described above may be used to store one or more of the data structures described above, such as order data. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer system may include one or more output devices. Example output devices include a cathode ray tube (CRT) display, liquid crystal displays (LCD) and other video output devices, printers, communication devices such as a modem or network interface, storage devices such as disk or tape, and audio output devices such as a speaker.

The computer system also may include one or more input devices. Example input devices include a keyboard, keypad, track ball, mouse, pen and tablet, communication devices such as described above, and data input devices such as audio and video capture devices and sensors. The computer system is not limited to the particular input or output devices described herein.

The computer system may include specially programmed, special purpose hardware, for example, an application-specific integrated circuit (ASIC). Such special-purpose hardware may be configured to implement one or more of the methods, acts, steps, system elements and systems described above.

The computer system and components thereof may be programmable using any of a variety of one or more suitable computer programming languages. The methods, acts, steps, system elements and systems described above may be implemented using any of a variety of suitable programming languages, including procedural programming languages, object-oriented programming languages, other languages and combinations thereof, which may be executed by such a computer system. Such languages may include procedural programming languages, for example, C, Pascal, Fortran and BASIC, object-oriented languages, for example, C++, Java and Eiffel and other languages, such as a scripting language or even assembly language. Such methods and acts may be implemented as separate modules of a computer program, or may be implemented individually as separate computer programs. Such modules and programs may be executed on separate computers.

The methods, acts, steps, systems, and system elements described above may be implemented in software, hardware or firmware, or any combination of the three, as part of the computer system described above or as an independent component.

Such methods, acts, steps, systems and system elements, either individually or in combination, may be implemented as one or more computer program products tangibly embodied as computer-readable signals (e.g., instructions) on a computer-readable medium, for example, a non-volatile recording medium, an integrated circuit memory element, or a combination thereof. For each such method, act and step, such a computer program product may comprise computer-readable signals tangibly embodied on the computer-readable that define instructions, for example, as part of one or more programs, that, as a result of being executed by a computer, instruct the computer to perform the method or act or step.

One example of the formation and settlement of a dispersion-based contract is provided as follows. On July 19^{th}, a first trading entity commits to buying one contract comprising one-thousand dollars per annualized percentage point of the twenty-trading-day realized non-centered volatility of the lognormal return of equity XYZ for the time period ending on August 16^{th} for $26,000. The contract specifies that the attribute is the lognormal return of equity XYZ's daily closing price as reported by the Wall Street Journal. Also on July 19^{th}, a second trading entity commits to the opposite position of selling one contract having the same specifications for $26,000. The realized volatility designated by both the first trading entity and the second trading entity covers the time period of July 22^{nd} through August 16^{th}. Through various intermediaries such as brokers, exchanges, clearing firms or clearinghouses, the first trading entity (in this example, “the buyer”) and the second trading entity (in this example, “the seller”) are matched and contracts are formed between the trading entities and an intermediary, such as a clearinghouse. Once the contracts are formed, the buyer makes a payment of $26,000 to the intermediary, and the intermediary places $26,000 in the seller's account. The daily closing price of the designated equity is then tracked from July 22^{nd} through August 16^{th} For the purposes of this example, a set of daily closing price data is provided in Table 1. From the daily closing price data, the daily lognormal equity returns can be calculated. The results of these calculations also are shown in Table 1.

TABLE 1

| DATE | PRICE | LOGNORMAL RETURN |
|---|---|---|
| 07/19 | 100.00 | |
| 07/22 | 102.20 | 2.18% |
| 07/23 | 102.50 | 0.29% |
| 07/24 | 100.70 | −1.77% |
| 07/25 | 99.65 | −1.05% |
| 07/26 | 97.50 | −2.18% |
| 07/29 | 99.00 | 1.53% |
| 07/30 | 101.80 | 2.79% |
| 07/31 | 104.80 | 2.90% |
| 08/01 | 106.05 | 1.19% |
| 08/02 | 103.80 | −2.14% |
| 08/05 | 103.00 | −0.77% |
| 08/06 | 100.90 | −2.06% |
| 08/07 | 97.60 | −3.33% |
| 08/08 | 98.20 | 0.61% |
| 08/09 | 98.10 | −0.10% |
| 08/12 | 101.44 | 3.35% |
| 08/13 | 102.81 | 1.34% |
| 08/14 | 103.42 | 0.59% |
| 08/15 | 100.70 | −2.67% |
| 08/16 | 103.23 | 2.48% |

| | |
|---|---|
| Annualized, Non-Centered Standard | |
| Deviation of Lognormal Returns | 32.00% |

Based on these observed results, the realized volatility is calculated and the contract value is determined and rounded to two decimal places. In this example, the realized volatility of equity XYZ from July 22^{nd} to August 16^{th} is calculated to be 32.00%. One contract of this volatility results in a payment of $32,000 by the second trading entity, and the receipt of a payment of $32,000 by the first trading entity. This example is provided by way of example only, and many other instruments, instrument attributes, and measures of dispersion may be used to form the contracts. For example, a different contract may have a payment that is based on the variance of the weekly close of a bond return over a one-year period.

As discussed above, the first trading entity and the second entity do not necessarily make payment directly to one another, or even necessarily contract with one another. In many cases, a clearinghouse or other high-credit intermediary holds contracts with both trading entities and is obligated to both trading entities. In this respect, a contract that is formed between the first trading entity and the second trading entity may actually take the form of two separate contracts between each trading entity and a clearinghouse. Other capital contributions and payment arrangements not discussed herein may be included as part of the various contracts.

Embodiments of the dispersion-based contracts described herein may be implemented in association with exchange-traded funds. For example, an exchange-traded fund may be based in whole or in part on one or more dispersion-based contracts. In other embodiments, established contract specifications or formed contracts are based on the dispersion of data associated with existing exchange-traded funds.

In view of the wide variety of embodiments to which the principles of the invention can be applied, it should be understood that the illustrated embodiments are exemplary only, and should not be taken as limiting the scope of the present invention. In addition, certain aspects of the present invention can be practiced with software, hardware, or a combination thereof. Accordingly, the invention is limited only by the following claims and equivalent thereto.

1. A computer-implemented method comprising the act of operating a computer to:
receive from a user indicia of an attribute of an instrument, wherein the instrument attribute may vary over time;
receive from a user indicia defining a time period for use in establishing contract specifications, the time period having an end time;
establish contract specifications to periodically measure the instrument attribute during the time period to generate instrument data;
establish contract specifications to calculate, after the end time, a contract value as a function of a measure of dispersion of the instrument data; and
establish contract specifications to periodically settle gains and losses as a function of market statistics associated with contracts that are based on the instrument attribute and the time period.

2. The method according to claim 1 wherein the indicia of the instrument attribute and the indicia defining the time period are received via an application programming interface of a computer system.

3. The method according to claim 1 wherein the indicia of the instrument attribute and the indicia defining the time period are received via a computer system terminal.

4. The method according to claim 1, wherein the contract specifications to calculate a contract value as a function of the measure of dispersion of the instrument data specify a method to calculate a deviation of the instrument data from a reference.

5. The method according to claim 4, wherein the specified method to calculate the deviation of the instrument data from a reference comprises calculating an average deviation of the instrument data from the reference.

6. The method according to claim 4, wherein the specified method to calculate the deviation of the instrument data comprises calculating a standard deviation of the instrument data from the reference.

7. The method according to claim 1, wherein the contract specifications to calculate a contract value as a function of the measure of dispersion of the instrument data specify a method to calculate a volatility of the instrument data.

8. The method according to claim 7, wherein the contract specifications to calculate a volatility of the instrument data specify a computer-implemented method to calculate a realized volatility of the instrument data.

9. The method according to claim 7, wherein the volatility is specified to be calculated as an annualized deviation of the instrument data from the mean of the instrument data.

10. The method according to claim 4, wherein the specified method to calculate the deviation of the instrument data from a reference comprises calculating a deviation of the instrument data from the mean of the instrument data.

11. The method according to claim 4, wherein the specified method to calculate the deviation of the instrument data from a reference comprises calculating a deviation of the instrument data from zero.

12. The method according to claim 4, wherein the specified method to calculate the deviation of the instrument data from a reference comprises calculating a deviation of the instrument data from an interest rate.

13. The method according to claim 1, wherein the instrument comprises one of an equity and a bond.

14. The method according to claim 1, wherein the instrument comprises one of a currency, an index, a future, a note and a bill.

15. The method according to claim 1, wherein the instrument comprises an asset.

16. The method according to claim 1, wherein the instrument attribute comprises an asset return.

17. The method according to claim 16, wherein the instrument attribute comprises a lognormal asset return.

18. The method according to claim 16, wherein the instrument attribute comprises a futures return.

19. The method according to claim 16, wherein the instrument attribute comprises an equity return.

20. The method according to claim 16, wherein the instrument attribute comprises an index return.

21. The method according to claim 16, wherein the instrument attribute comprises a lognormal equity return.

22. The method according to claim 1, wherein the instrument comprises a derivative on a dispersion-based contract.

23. The method according to claim 1, wherein the contract specifications to calculate a contract value as a function of the measure of dispersion of the instrument data specify a method to calculate a variance of the instrument data.

24. The method according to claim 1, wherein the contract specifications to calculate a contract value as a function of the measure of dispersion of the instrument data specify a method to calculate a range of the instrument data.

25. The method according to claim 1, wherein the contract specifications to calculate a contract value as a function of the measure of dispersion of the instrument data specify a method to calculate a trimmed range of the instrument data.

26. The method according to claim 1, wherein the contract specifications to calculate a contract value as a function of the measure of dispersion of the instrument data specify a method to calculate a Parkinson volatility of the instrument data.

27. The method according to claim 1, wherein the contract specifications to calculate a contract value as a function of the measure of dispersion of the instrument data specify the performance of a computational simulation to evaluate the dispersion of the instrument data.

28. The method according to claim 1, wherein the contract specifications are consistent with the specification of a mark-to-market procedure.

29. The method according to claim 1, wherein the contract specifications to calculate a contract value as a function of a measure of dispersion of the instrument data specify calculating a contract value as multiple of a measure of dispersion of the instrument data.

30. The method according to claim 1, further comprising operating a computer to execute the act of:
periodically settling gains and losses as a function of market statistics associated with contracts that are based on the instrument attribute and the time period.

31. The method according to claim 1, further comprising operating a computer to execute the act of:
calculating, after the end time, a contract value as a function of the measure of dispersion of the instrument data.

32. The method according to claim 31, wherein the measure of dispersion of the instrument data comprises a deviation of the instrument data from a reference.

33. The method according to claim 31, wherein the measure of the dispersion of the instrument data comprises a volatility of the instrument data.

34. The method according to claim 31, wherein the measure of the dispersion of the instrument data comprises a variance of the instrument data.

35. The method according to claim 31, wherein the measure of dispersion of the instrument data comprises performing a computational simulation to estimate the dispersion of the instrument data.

36. An electronic system comprising:
a memory unit;
an input interface to receive data from trading entities;
a processor operatively connectable to the memory unit and input interface and provided with a program which when executed by the processor effectuates control of the memory unit, input interface and operations of the electronic system to
(a) allow a first trading entity to input a first set of order data indicative of an order price, a type of contract, and a position, wherein the indicated type of contract is a contract that specifies:
an instrument having an instrument attribute that may vary over time;
a time period having an end time;
a method to periodically measure the instrument attribute to generate instrument data; and
a method to calculate, after the end time, a contract value as a function of a measure of dispersion of the instrument data;
(b) search the memory for a second set of order data that indicates the same type of contract as the first set of order data, a position opposite to the position of the first set of order data, and an order price that is compatible with forming a contract between the first trading entity and a second trading entity, the second set of order data having been provided by the second trading entity;
(c) initiate the formation of a first contract between the first trading entity and an intermediary; and
(d) initiate the formation of a second contract between the second trading entity and the intermediary.

37. The electronic system according to claim 36, wherein the input interface is operatively connectable to an application programming interface of a computer system.

38. The electronic system according to claim 36, wherein the input interface is operatively connectable to a computer system terminal.

39. The electronic system according to claim 36, wherein the intermediary is a credit-worthy institution.

40. The electronic system according to claim 39, wherein the intermediary is a clearinghouse.

41. The electronic system according to claim 36, wherein the contract specifies a mark-to-market procedure.

42. The electronic system according to claim 36, wherein the processor effectuates control of the memory unit, input interface and operations of the electronic system to:
(e) initiate the formation of a third contract, of the same indicated type, between a third trading entity and the intermediary, wherein the third trading entity is financially-independent of both the first trading entity and the second trading entity.

43. The electronic system according to claim 42, wherein the processor effectuates control of the memory unit, input interface and operations of the electronic system to:
(f) initiate the formation of a fourth contract, of the same indicated type, between a fourth trading entity and the intermediary, wherein the fourth trading entity is financially-independent of the first trading entity, the second trading entity and the third trading entity.

44. The electronic system according to claim 36, wherein the instrument attribute is an asset price.

45. The electronic system according to claim 36, wherein the instrument attribute is an asset return.

46. The electronic system according to claim 36, wherein the instrument is a derivative on a dispersion-based contract.

47. The electronic system according to claim 36, wherein the contract specifies a method to calculate, after the end time, the contract value as function of a deviation of the instrument data from a reference.

48. The electronic system according to claim 36, wherein the contract specifies a method to calculate, after the end time, the contract value as function of a volatility of the instrument data.

49. The electronic system according to claim 36, wherein a method to calculate, after the end time, a contract value as a multiple of the measure of dispersion of the instrument data.

50. A computer-implemented method comprising the act of operating a computer to:
form a first electronic order by
receiving from a user indicia designating an instrument having an instrument attribute that may vary over time and can be measured to generate instrument data,
receiving from the user indicia defining a time period having an end time,
receiving from the user indicia of an order price,
receiving from the user indicia of a contract type, wherein the indicated contract type includes specifications for a trading entity to one of make and receive a payment after the time period, the payment calculated as a function of a measure of dispersion of the instrument data, and
processing the indicia into the first electronic order;
communicate the first electronic order to a computer system programmed to facilitate matching of the first electronic order to a second, complementary order; and
receive confirmation of the first electronic order having been matched to a second, complementary order.

51. The method according to claim 50, wherein at least one of the indicia is received via an application programming interface of a computer system.

52. The method according to claim 50, wherein at least one of the indicia is received via a computer system terminal.

53. The method according to claim 50, wherein the instrument comprises a derivative on a dispersion-based contract.

54. The method according to claim 50, wherein the indicated contract type includes specifications that the contract be periodically marked-to-market.

55. The method according to claim 50, wherein the indicated contract type includes specifications that the payment is calculated as a multiple of the measure of dispersion of the instrument data.

56. The method according to claim 55, wherein the trading entity associated with the first electronic order makes an initial payment for the contract before the end time.

57. The method according to claim 56, wherein a trading entity associated with the complementary order makes payment after the end time, the payment calculated as a function of the measure of dispersion of the instrument data.

58. The method according to claim 50, wherein the computer system programmed to facilitate the matching of the first electronic order to a second, complementary order comprises a processor programmed to search a storage medium for a complementary order.

59. The method according to claim 50, wherein the computer system programmed to facilitate the matching of the first electronic order to a second, complementary order comprises a processor programmed to direct the first electronic order to an appropriate entity.

60. The method according to claim 59, wherein the appropriate entity is a person.

61. The method according to claim 50, further comprising the act of operating a computer to:
form a third electronic order for a contract of the indicated contract type;
communicate the third electronic order to a computer system programmed to facilitate matching the third electronic order to a fourth, complementary order; and
receive confirmation of the third electronic order having been matched to the fourth, complementary order, wherein the third electronic order is financially-independent of the first electronic order and the second order.

62. The method according to claim 61, wherein the fourth order is financially-independent of the first electronic order, the second order and the third electronic order.

63. The method according to claim 50, wherein the computer system programmed to facilitate matching the first electronic order to a second, complementary order is part of the computer operated to form the first electronic order.
